(19) United States
(12) Patent Application Publication
(10) Pub. No.: US 2020/0408683 A1
(43) Pub. Date: Dec. 31, 2020

(54) LIGHT SCATTERING DETECTION DEVICE AND LIGHT SCATTERING DETECTION METHOD

(71) Applicant: Shimadzu Corporation, Kyoto (JP)

(72) Inventors: Toru YAMAGUCHI, Kyoto (JP); Atsushi KASATANI, Kyoto (JP)

(21) Appl. No.: 16/911,836

(22) Filed: Jun. 25, 2020

(30) Foreign Application Priority Data
Jun. 26, 2019 (JP) 2019-118673

(51) Int. Cl. G01N 21/51; G01N 15/02

(52) U.S. Cl. CPC G01N 21/51; G01N 2021/4711; G01N 15/0211

(57) ABSTRACT

A light scattering detection device and a light scattering detection method are provided that are capable of maintaining, for example, good calculation accuracy of molecular weight and particle size without depending on the arrangement angles of detectors. A light scattering detection device 1 includes a sample cell 2, a light source 3 to irradiate the sample cell 2 with coherent light L1, a plurality of detectors 4 to receive scattering light L2 with different scattering angles around the sample cell 2, and a plurality of apertures 5 to partly prevent the scattering light L2, wherein the sample cell 2 has a sample channel 22 to enclose a liquid sample Q, the light source 3 is arranged to cause the coherent light L1 incident on one end side of the sample channel 22 to pass through the sample channel 22, the detectors 4 are arranged on a circumference about a central axis O₂₁ of the sample cell 2 extending in a vertical direction (Z axis direction), and each aperture 5 has an opening width W₅₁ to be maximum at an arrangement angle θ of 90° and to decrease with the arrangement angle away from 90°.

### BACKGROUND OF THE INVENTION

### 1. Field of the Invention

The present invention relates to a light scattering detection device and a light scattering detection method.

### 2. Description of the Related Art

As a technique to separate fine particles, such as protein, dispersed in a liquid sample, size exclusion chromatography (SEC) and gel permeation chromatography (GPC) are used. As chromatographic detection devices used in recent years, there are multi-angle light scattering (MALS) detection devices in addition to ultraviolet (UV) absorbance detection devices and differential refractive index detection devices. Such a multi-angle light scattering detection device is characterized as being capable of calculating the molecular weight and the particle size of a measured sample.

As the multi-angle light scattering detection device, there is a detection device including: a cell having a through hole that is formed radially through the cell and is used to fill the cell with a liquid sample; a light source configured to irradiate the through hole with a beam; and a plurality of detectors arranged at intervals along an outer periphery of the cell and configured to receive scattering light from the cell (liquid sample) (e.g., refer to JP 561(1986)-120947 A).

To partly prevent the scattering light from being incident on the detectors in the multi-angle light scattering detection device according to JP 561(1986)-120947 A, there is a detection device configured to have additional apertures (refer to FIG. 10). A conventional multi-angle light scattering detection device 1000 illustrated in FIG. 10 includes: a cell 1002 having a through hole 1001 formed radially (X axis direction) through the cell and is used to fill the cell with a liquid sample Q; a light source 1003 configured to irradiate the through hole 1001 with a beam BM; a condenser lens 1007 arranged between the cell 1002 and the light source 1003; a plurality of detectors 1004 arranged at intervals along an outer periphery of the cell 1002 and configured to receive scattering light from the cell 1002 (liquid sample Q); and a plurality of apertures 1006 arranged between the cell 1002 and the respective detectors 1004 to partly prevent scattering light from being incident on the detectors 1004 by a width of respective openings 1005.

FIG. 10 illustrates, as representative examples of the detectors 1004 and the apertures 1006, a detector 1004A positioned at an arrangement angle θ₁, a first aperture 1006A-1 and a second aperture 1006A-2, a detector 1004B positioned at an arrangement angle θ₂ greater than the arrangement angle θ₁, a first aperture 1006B-1 and a second aperture 1006B-2. The first aperture 1006A-1, the second aperture 1006A-2, the first aperture 1006B-1, and the second aperture 1006B-2 all have the respective openings 1005 with the same width.

As illustrated in FIG. 11, in the multi-angle light scattering detection device 1000, a region where the reception area of the detector 1004A at the arrangement angle θ₁ and the scattering light generation area overlap is greater than a region where the reception area of the detector 1004B at the arrangement angle θ₂ and the scattering light generation area overlap. It is accordingly understood that, in the multi-angle light scattering detection device 1000, the scattering light generation area received by the detectors 1004 tends to be greater with the arrangement angle away from 90 degrees. Even if the respective detectors are arranged in positions at an equal distance from the center of the cell as illustrated in the graph of FIG. 12, difference in arrangement angle thus causes variation in the scattering light generation area where the respective detectors receive the light. The variation becomes an error in, for example, calculation of the molecular weight and the particle size and thus causes difficulty of accurate calculation.

### SUMMARY

It is an object of the present invention to provide a light scattering detection device and a light scattering detection method that are capable of maintaining, for example, good calculation accuracy of molecular weight and particle size without depending on the arrangement angles of detectors.

A first aspect of the present invention relates to a light scattering detection device for detecting fine particles in a liquid sample, including: a transparent sample cell configured to retain the liquid sample; a light source configured to irradiate the sample cell with coherent light; a plurality of detectors configured to receive scattering light with different scattering angles around the sample cell; and a plurality of apertures arranged between the sample cell and the respective detectors and configured to partly prevent the scattering light from being incident on the detectors, the geometric range of the prevention being defined by opening widths of the apertures, wherein the sample cell has a sample channel formed linearly through the sample cell, the channel configured to enclose the liquid sample, the light source is arranged to pass the coherent light incident on one end side of the sample channel through the sample channel, the plurality of detectors are arranged on a circumference about a central axis of the sample cell, the central axis extending vertically, the detectors includes, where a position at an angle of 90° to an incident direction of the coherent light on the sample cell is defined as a reference position, first and second detectors arranged in proximal and distal positions with respect to the reference position, respectively, and a first aperture for the first detector has a greater opening width than a second aperture for the second detector.

A second aspect of the present invention relates to a light scattering detection method for detecting fine particles in a liquid sample, including the steps of: enclosing the liquid sample in a sample channel formed linearly through a transparent sample cell configured to retain the liquid sample; irradiating coherent light from a light source from one end side of the sample channel to pass the coherent light through the sample channel; and receiving scattering light with different scattering angles around the sample cell by a plurality of detectors arranged on a circumference about a central axis of the sample cell extending vertically, wherein the receiving scattering light includes partly preventing the scattering light from being incident on the respective detectors, the geometric range of the prevention being defined by opening widths of a plurality of apertures arranged between the sample cell and the respective detectors, the plurality of detectors includes, where a position at an angle of 90° to an incident direction of the coherent light on the sample cell is defined as a reference position, first and second detectors arranged in proximal and distal positions with respect to the reference position, respectively, and a first aperture for the first detector has a greater opening width than a second aperture for the second detector.

The present invention allows matching, that is, equalizing the size of the region where the reception area of each detector and the scattering light generation area overlap regardless of the arrangement angle. The light intensity in each detector thus becomes substantially same, that is, falls within tolerance. It is thus possible to maintain, for example, good calculation accuracy of molecular weight and particle size without depending on the arrangement angles of the detectors.

### BRIEF DESCRIPTION OF THE DRAWINGS

FIG. 1 is a plan view illustrating a light scattering detection device in a first embodiment of the present invention.

FIG. 2 is a graph illustrating a relative value of the intensity of scattering light received by each detector at each arrangement angle in the case of using the light scattering detection device illustrated in FIG. 1.

FIG. 3 is a flow chart illustrating the order of steps in a light scattering detection method of the present invention.

FIG. 4 is a plan view illustrating a light scattering detection device in a second embodiment of the present invention.

FIG. 5 is a graph illustrating the light intensity at each arrangement angle in the case of using the light scattering detection device illustrated in FIG. 2 in a moving mechanism stop state.

FIG. 6 is a graph illustrating a relative value of the intensity of scattering light received by each detector at each arrangement angle in the case of using the light scattering detection device illustrated in FIG. 2 in a moving mechanism activated state.

FIG. 7 is a plan view illustrating a light scattering detection device in a third embodiment of the present invention.

FIG. 8 is a plan view illustrating a light scattering detection device in a fourth embodiment of the present invention.

FIG. 9 is a graph illustrating a relative value of the intensity of scattering light received by each detector at each arrangement angle in the case of using the light scattering detection device illustrated in FIG. 8.

FIG. 10 is a plan view illustrating the configuration of a conventional light scattering detection device.

FIG. 11 is a diagram illustrating the difference in a scattering light generation area where each detector receives the light in the light scattering detection device illustrated in FIG. 10.

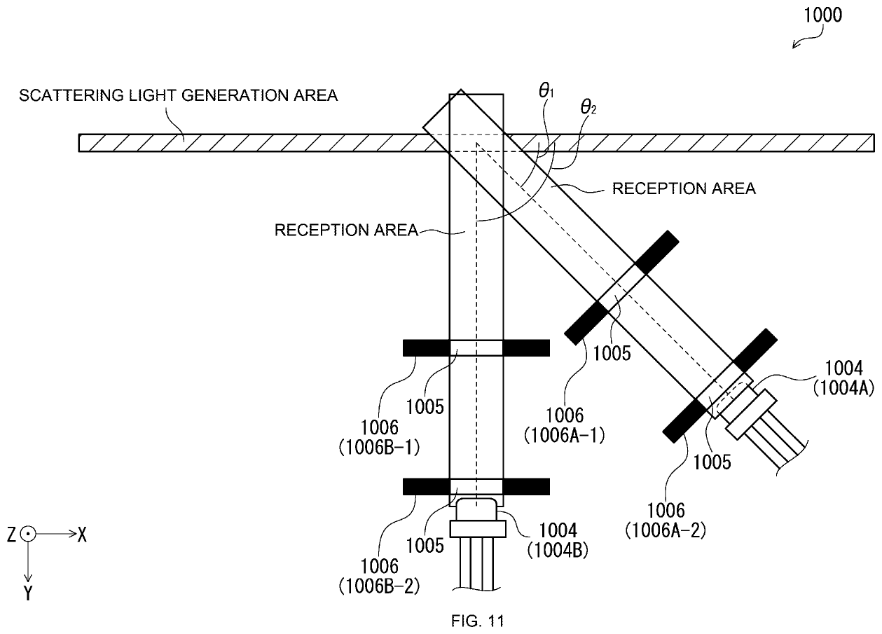

FIG. 12 is a graph illustrating a relative value of the intensity of scattering light received by each detector at each arrangement angle in the case of using the light scattering detection device illustrated in FIG. 10.

### DETAILED DESCRIPTION OF THE PREFERRED EMBODIMENTS

The light scattering detection device and the light scattering detection method of the present invention are described below in detail based on preferred embodiments illustrated in the attached drawings.

### First Embodiment

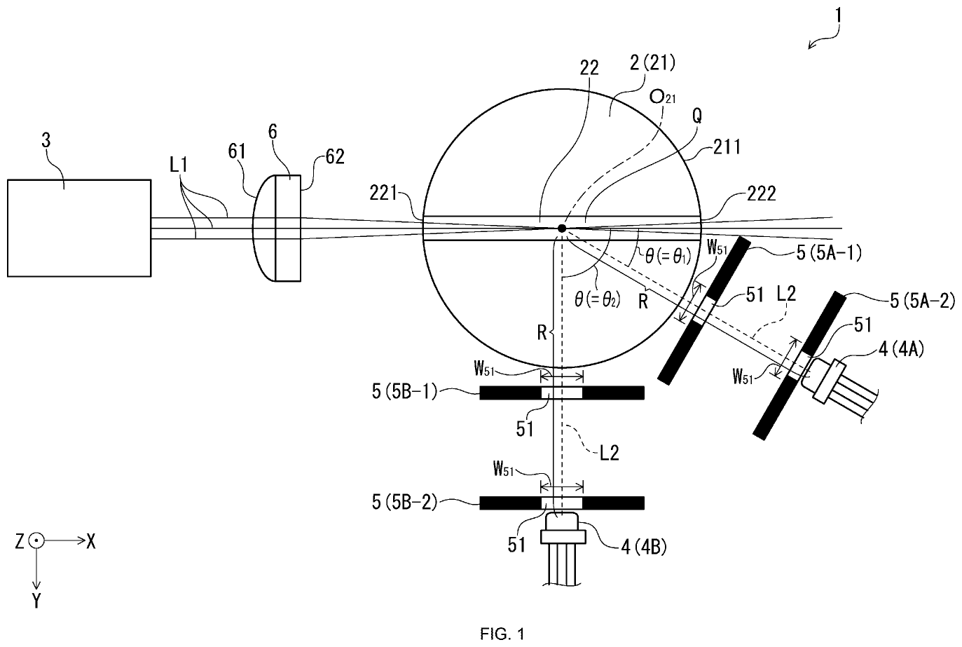

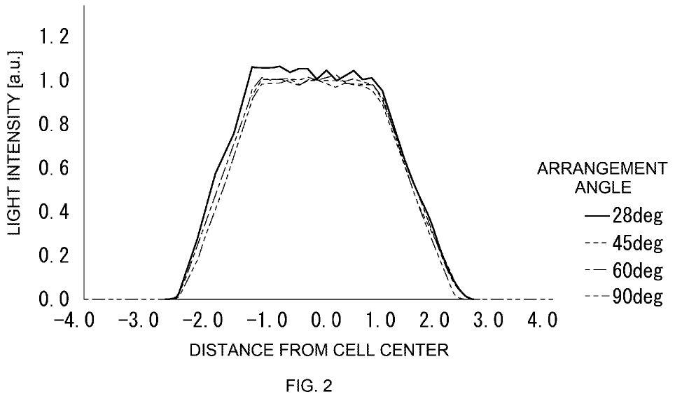

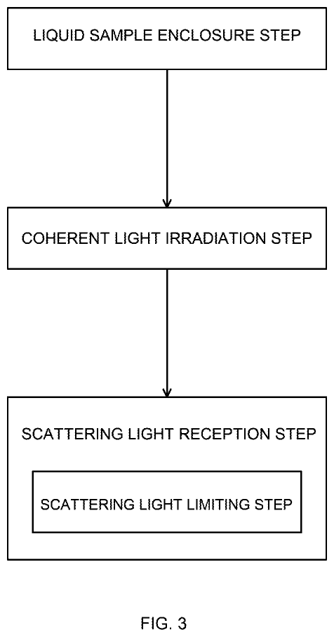

FIG. 1 is a plan view illustrating a light scattering detection device in the first embodiment of the present invention. FIG. 2 is a graph illustrating a relative value of the intensity of scattering light received by each detector at each arrangement angle in the case of using the light scattering detection device illustrated in FIG. 1. FIG. 3 is a flow chart illustrating the order of steps in a light scattering detection method of the present invention. In the following description, for the convenience of description, one direction out of the horizontal directions is referred to as an “X axis direction”, a direction orthogonal to the X axis direction out of the horizontal directions is referred to as a “Y axis direction”, and the vertical direction, that is, a direction orthogonal to the X axis direction and the Y axis direction is referred to as a “Z axis direction”. The arrow side in each axis direction may be referred to as a “positive side” and the other side from the arrow head as a “negative side”. The graphs illustrated in FIGS. 2, 6, 9, and 12 are all results of calculating, where the light intensity of the received scattering light generated at the cell center (x=0) is defined as 1, the cell position dependence (x dependence) of a relative value of the intensity of the received scattering light.

A light scattering detection device 1 of the present invention illustrated in FIG. 1 is a multi-angle light scattering (MALS) detection device for detecting a molecular weight, a gyration radius (size), and the like of fine particles, such as protein, dispersed in a liquid sample Q. The light scattering detection device 1 includes a transparent sample cell 2 configured to retain the liquid sample Q a light source 3 configured to irradiate the sample cell 2 with coherent light L1, a condenser lens 6 configured to converge the coherent light L1 incident on the sample cell 2, a plurality of detectors 4 configured to receive scattering light L2 from the sample cell 2 (liquid sample Q), and a plurality of apertures 5 configured to partly prevent the scattering light L2 from being incident on the detectors 4.

The light scattering detection method of the present invention is a method of detecting a molecular weight, a gyration radius, and the like of fine particles, such as protein, dispersed in the liquid sample Q using the light scattering detection device 1. As illustrated in FIG. 3, this light scattering detection method includes the steps of: enclosing liquid sample (first step), irradiating coherent light (second step), and receiving scattering light (third step) and these steps are sequentially executed.

As illustrated in FIG. 1, the sample cell 2 has a cylindrical portion 21 formed in a cylindrical shape and has a central axis O₂₁ arranged in parallel with the Z axis direction. The cylindrical portion 21 has a sample channel 22 formed linearly through the cylindrical portion 21 (sample cell 2) in the X axis direction and configured to enclose the liquid sample Q. The sample channel 22 preferably intersects the central axis O₂₁.

The cylindrical portion 21 is constituted by a transparent material and an example of the component material includes, but not particularly limited to, colorless transparent quartz glass.

In the liquid sample enclosure step, the liquid sample Q is enclosed in the sample channel 22. The enclosing activity may be performed, for example, automatically by an enclosing device or manually by a worker.

The light source 3 irradiates the sample cell 2 with the coherent light L1. The “coherent light” is light in which the phase relationship of light waves at two arbitrary points in luminous flux is temporally invariant and kept constantly, and even when the luminous flux is divided by an arbitrary method and then superimposed again with a large optical path difference, complete coherence is exhibited. An example of the light source 3 to be employed includes a laser light source to irradiate visible laser light. There is no completely coherent light L1 in the natural world, and laser light oscillating in a single mode is a light close to a coherent state.

The light source 3 is arranged on a negative side in the X axis direction relative to the sample cell 2 and faces one end 221 side of the sample channel 22. The coherent light L1 emitted from the light source 3 is thus incident from the one end 221 side of the sample channel 22. The coherent light L1 then passes through the sample channel 22 and exits from the other end 222 side of the sample channel 22.

In the coherent light irradiation step, the sample cell 2 is irradiated with the coherent light L1 using the light source 3. This allows irradiation with the coherent light L1 from the one end 221 side of the sample channel 22 to pass the coherent light L1 from the light source 3 through the sample channel 22.

Between the light source 3 and the sample cell 2, the condenser lens 6 is arranged. The condenser lens 6 is a planoconvex lens with a convex surface 61 on the incident side of the coherent light L1 and a plane surface 62 on the exit side.

It should be noted that, in the light scattering detection device 1, a condenser optical system configured by combining a plurality of compound lenses and condenser mirrors may be arranged instead of the condenser lens 6. Such a condenser optical system is also capable of, similar to the condenser lens 6, converging the coherent light L1 incident on the sample cell 2.

Around the sample cell 2, the plurality of detectors 4 are arranged away from an outer peripheral surface 211 of the cylindrical portion 21. As described earlier, the coherent light L1 passes through the sample channel 22. During the passage, the coherent light L1 then scatters, due to the liquid sample Q, around the sample cell 2 with different scattering angles to be the scattering light L2. Each detector 4 is capable of receiving the scattering light L2. In addition, in the light scattering detection device 1, the outer peripheral surface 211 of the cylindrical portion 21 functions as a lens with its focus position where a reception surface of each detector 4 is positioned. The detectors 4 accordingly has the reception surfaces arranged on the circumference about the central axis O₂₁ of the sample cell 2 extending vertically, that is, on a circumference with a radius R.

Note that FIG. 1 illustrates representative examples of the detectors 4 as, where a position at an angle of 90° to the incident direction of the coherent light L1 on the sample cell 2 is defined as a reference position, a detector (first detector) 4A arranged in a proximal position with respect to the reference position, that is, positioned at an arrangement angle θ₁ and a detector (second detector) 4B arranged in a distal position with respect to the reference position, that is, positioned at an arrangement angle θ₂ greater than the arrangement angle θ₁. Although photodiodes are employed as the detectors 4 in the present embodiment, the detectors 4 are not limited to them and may be, for example, array detectors such as two dimensional CMOS sensors.

In the scattering light reception step, it is possible to receive the scattering light L2 by the detectors 4 arranged on the circumference on the XY plane about the central axis O₂₁ of the sample cell 2.

Between the sample cell 2 and the respective detectors 4, the plurality of apertures 5 are arranged at intervals in an optical axis direction of the scattering light L2. Each of the apertures 5 has an opening 51 formed through in the optical axis direction of the scattering light L2. The opening 51 has at least a side in the vertical direction in a linear shape and preferably has a rectangular shape that is oriented longitudinal in the vertical direction (Z axis direction). Each aperture 5 is capable of partly preventing the scattering light L2 from being incident on the detector 4 corresponding to the aperture 5, the geometric range of the prevention being defined by an opening width W₅₁ of the opening 51.

The scattering light reception step includes a scattering light partly preventing step to partly prevent the scattering light L2 from being incident on the respective detectors 4, the geometric range of the prevention being defined by the opening widths W₅₁ of the apertures 5 arranged between the sample cell 2 and the respective detectors 4 (refer to FIG. 3).

It should be noted that FIG. 1 illustrates representative examples of the apertures 5 as a first aperture plate 5A-1 positioned on the sample cell 2 side and a second aperture plate 5A-2 positioned on the detector 4 side that are arranged between the sample cell 2 and the detector 4A and a first aperture plate 5B-1 positioned on the sample cell 2 side and a second aperture plate 5B-2 positioned on the detector 4 side that are arranged between the sample cell 2 and the detector 4B.

The first aperture plate 5A-1 and the second aperture plate 5A-2 positioned at the arrangement angle θ₁ have the same opening width W₅₁ and partly prevent the scattering light L2 from being incident on the detector 4A in a stepwise manner. Meanwhile, the first aperture plate 5B-1 and the second aperture plate 5B-2 positioned at the arrangement angle θ₂ also have the same opening width W₅₁ and partly prevent the scattering light L2 from being incident on the detector 4B in a stepwise manner.

In the light scattering detection device 1, the opening widths W₅₁ of the respective apertures 5 are different in accordance with the arrangement angle θ. That is, the opening widths W₅₁ of the respective apertures 5 are maximum at the arrangement angle θ of 90° and decrease with the arrangement angle θ away from 90°. As illustrated in FIG. 1, the opening width W₅₁ at the arrangement angle θ₁ is accordingly smaller than the opening width W₅₁ at the arrangement angle θ₂. In the present embodiment, where the opening width W₅₁ at the arrangement angle θ of 90° is W_{51(MAX)}, the opening width W₅₁ of each aperture 5 is a value (=W_{51(MAX)}×R×sin θ) obtained by multiplying the opening width W_{51(MAX)} by a distance from the central axis O₂₁ of the sample cell 2 to the detector 4, that is, the radius R by the sine value of the arrangement angle θ of the detector 4. It should be noted that, as long as the object of the present invention is achieved, the scope of the present invention includes slightly corrected values as this value.

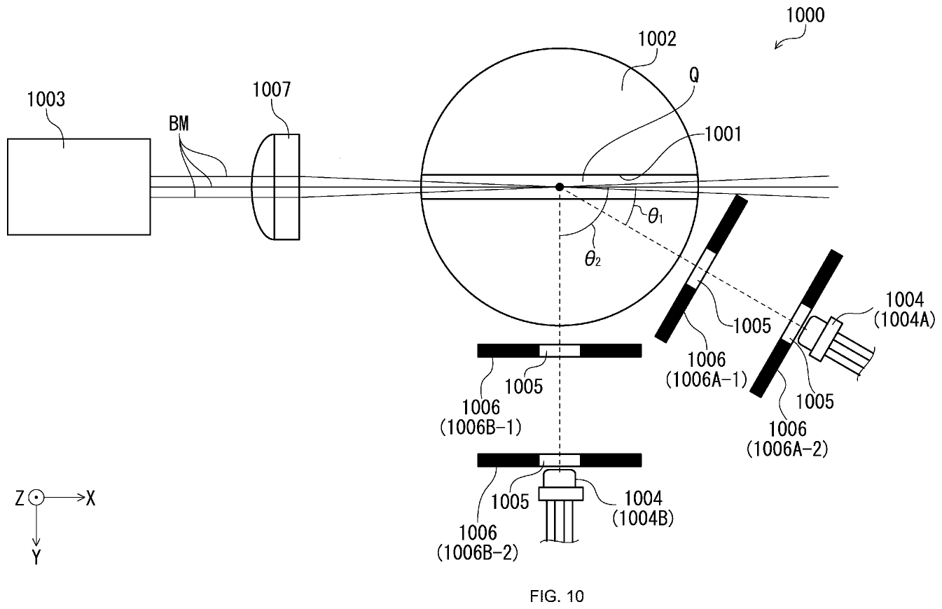

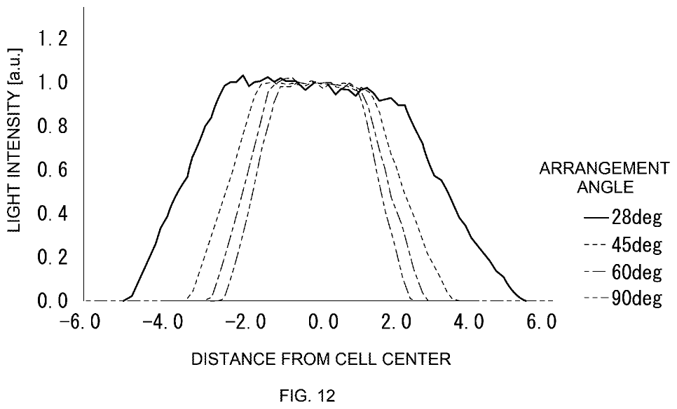

As described earlier, in the case of equalized opening widths W₅₁ regardless of the arrangement angle θ, the scattering light generation area where each detector 4 receives the light varies even if each detector 4 is arranged in a position at an equal distance from the central axis O₂₁ of the sample cell 2 (refer to FIGS. 10 and 12). The variation becomes an error in, for example, calculation of the molecular weight and the particle size and thus causes difficulty of accurate calculation.

In contrast, in the light scattering detection device 1, the opening widths W₅₁ are different as described above in accordance with the arrangement angle θ. In this case, it is possible to match, that is, equalize the size of the region where the reception area of each detector 4 and the scattering light generation area overlap regardless of the arrangement angle θ, and as a result of detection by each detector 4, the graph in FIG. 2 is thus obtained. As illustrated in the graph of FIG. 2, when each detector 4 is arranged in a position at an equal distance from the central axis O₂₁ of the sample cell 2, the light intensity in each detector 4 thus becomes substantially same, that is, falls within tolerance. The light scattering detection device 1 is thus capable of accurate calculation of, for example, the molecular weight and the particle size, that is, maintaining good calculation accuracy of molecular weight and particle size without depending on the arrangement angles θ of the detectors 4. It should be noted that the graph in FIG. 2 is a result in the case where the refractive index of the solvent in the liquid sample Q is same (e.g., a refractive index of 1.46) as the refractive index of the sample cell 2 (cylindrical portion 21).

### Second Embodiment

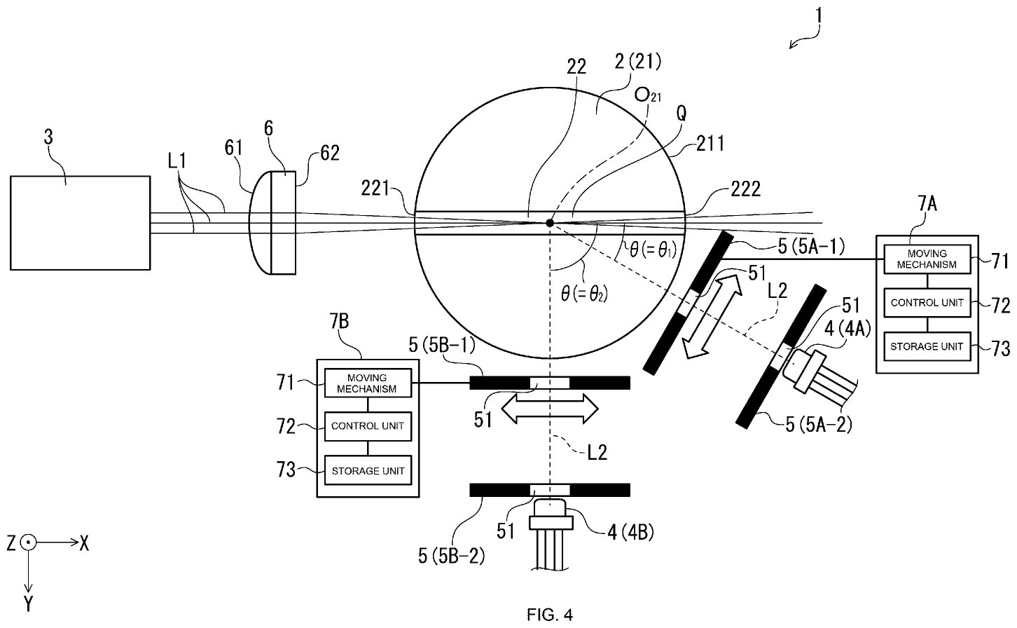

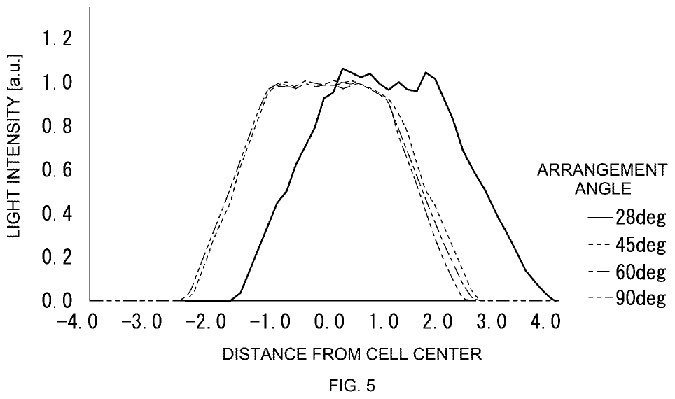

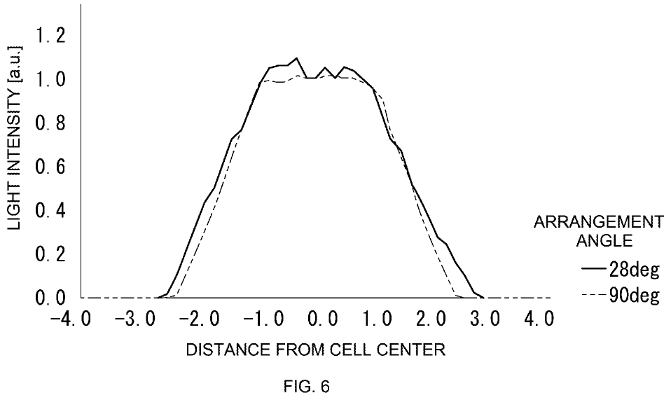

FIG. 4 is a plan view illustrating a light scattering detection device in the second embodiment of the present invention. FIG. 5 is a graph illustrating a relative value of the intensity of scattering light received by each detector at each arrangement angle in the case of using the light scattering detection device illustrated in FIG. 2 in a moving mechanism stop state. FIG. 6 is a graph illustrating a relative value of the intensity of scattering light received by each detector at each arrangement angle in the case of using the light scattering detection device illustrated in FIG. 2 in a moving mechanism activated state.

While the light scattering detection device and the light scattering detection method in the second embodiment of the present invention are described below with reference to these drawings, the description is mainly given to the difference from the embodiment described earlier to omit the description on similar points.

The present embodiment is same as the first embodiment except for including a moving mechanism configured to move a first aperture plate.

As illustrated in FIG. 4, a light scattering detection device 1 in the present embodiment includes a moving unit 7A configured to move the first aperture plate 5A-1 and a moving unit 7B configured to move the first aperture plate 5B-1. The moving unit 7A and the moving unit 7B have the same configuration except for moving different target apertures 5, and thus the moving unit 7A is described below as a representative example. In the light scattering detection device 1, the moving unit 7B may be omitted depending on the magnitude of the arrangement angle θ₂.

The moving unit 7A includes a moving mechanism 71 configured to move the first aperture plate 5A-1 relative to the second aperture plate 5A-2, a control unit 72 configured to control activation of the moving mechanism 71, and a storage unit 73 configured to store the refractive index information of the solvent in the liquid sample Q.

The moving mechanism 71 is coupled to the first aperture plate 5A-1 and is configured with, for example, a motor, a ball screw, a linear guide, and the like. The moving mechanism 71 is capable of moving the first aperture plate 5A-1 horizontally in parallel with the second aperture plate 5A-2, that is, in a tangent direction on the outer peripheral surface 211 at the intersection of the outer peripheral surface 211 of the sample cell 2 and the optical axis of the scattering light L2 towards the detector 4A.

In the storage unit 73, refractive index information of solvents in various liquid samples Q is stored.

The control unit 72 extracts the refractive index information of the solvent in the liquid sample Q as a target for analysis from the storage unit 73. The control unit 72 then activates the moving mechanism 71 based on the extracted refractive index information of the solvent to control the amount of movement (moving distance) of the first aperture plate 5A-1.

In the scattering light partly preventing step, it is possible to move the first aperture plate 5A-1 horizontally in parallel with the second aperture plate 5A-2 based on the refractive index information of the solvent in the liquid sample Q.

In the case where the refractive index of the solvent in the liquid sample Q is different from the refractive index of the sample cell 2 (cylindrical portion 21) (e.g., the solvent has refractive index of 1.333 and the sample cell 2 has a refractive index of 1.46), a result as the graph illustrated in FIG. 5 is obtained while the moving unit 7A and the moving unit 7B remain stopped. As clearly understood from the graph in FIG. 5, the light intensity in each detector 4 at a smaller arrangement angle θ (e.g., the case of an arrangement angle θ of 28 degrees) tends to deviate from the light intensity at a greater arrangement angle θ.

In order to prevent the deviation of the light intensity due to the magnitude of the arrangement angle θ even in the case where the refractive index of the solvent in the liquid sample Q is different from the refractive index of the sample cell 2 (cylindrical portion 21), the light scattering detection device 1 is capable of moving the first aperture plate 5A-1 positioned at the arrangement angle θ₁ smaller in the arrangement angle θ relative to the second aperture plate 5A-2 as described earlier. This results in the graph as illustrated in FIG. 6. As clearly understood from the graph in FIG. 6, the graph of light intensity corresponding to each arrangement angle θ substantially overlaps with each other regardless of the magnitude of the arrangement angle θ and the deviation is thus prevented. This allows accurate calculation of, for example, the molecular weight and the particle size regardless of the positions where the detectors 4 are arranged.

### Third Embodiment

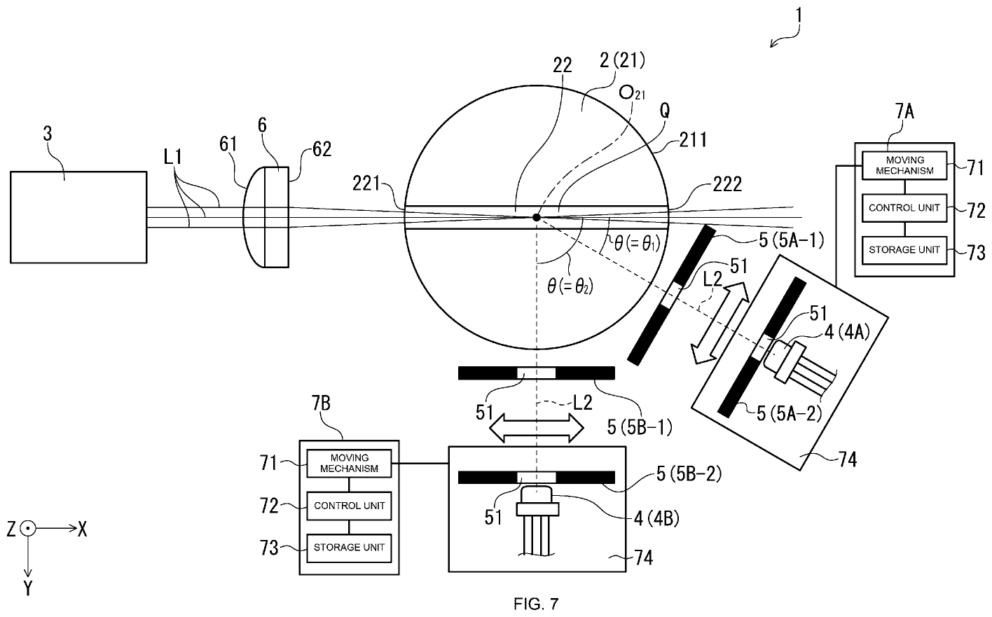

FIG. 7 is a plan view illustrating a light scattering detection device in the third embodiment of the present invention.

While the light scattering detection device and the light scattering detection method in the third embodiment of the present invention are described below with reference to this drawing, the description is mainly given to the difference from the embodiments described earlier to omit the description on similar points.

The present embodiment is same as the second embodiment except for moving a different target object by a moving unit.

As illustrated in FIG. 7, in the present embodiment, a moving unit 7A is configured to move the second aperture plate 5A-2 and the detector 4A and a moving unit 7B is configured to move the second aperture plate 5B-2 and the detector 4B. In the present embodiment as well, the moving unit 7A and the moving unit 7B have the same configuration except for moving different target apertures 5, and thus the moving unit 7A is described below as a representative example.

A moving mechanism 71 of the moving unit 7A is coupled to a base 74 on which the second aperture plate 5A-2 and the detector 4A are placed and is capable of collectively moving the second aperture plate 5A-2 and the detector 4A horizontally in parallel with the first aperture plate 5A-1.

The control unit 72 activates the moving mechanism 71 based on the refractive index information of the solvent extracted from the storage unit 73 to control the amount of movement (moving distance) of the second aperture plate 5A-2 and the detector 4A.

In the scattering light partly preventing step, it is possible to move the second aperture plate 5A-2 and the detector 4A horizontally in parallel with the first aperture plate 5A-1 based on the refractive index information of the solvent in the liquid sample Q.

By the configuration as just described, it is possible to prevent the deviation in the light intensity detected by each detector 4 regardless of the magnitude of the arrangement angle θ. This allows accurate calculation of, for example, the molecular weight and the particle size regardless of the positions where the detectors 4 are arranged.

### Fourth Embodiment

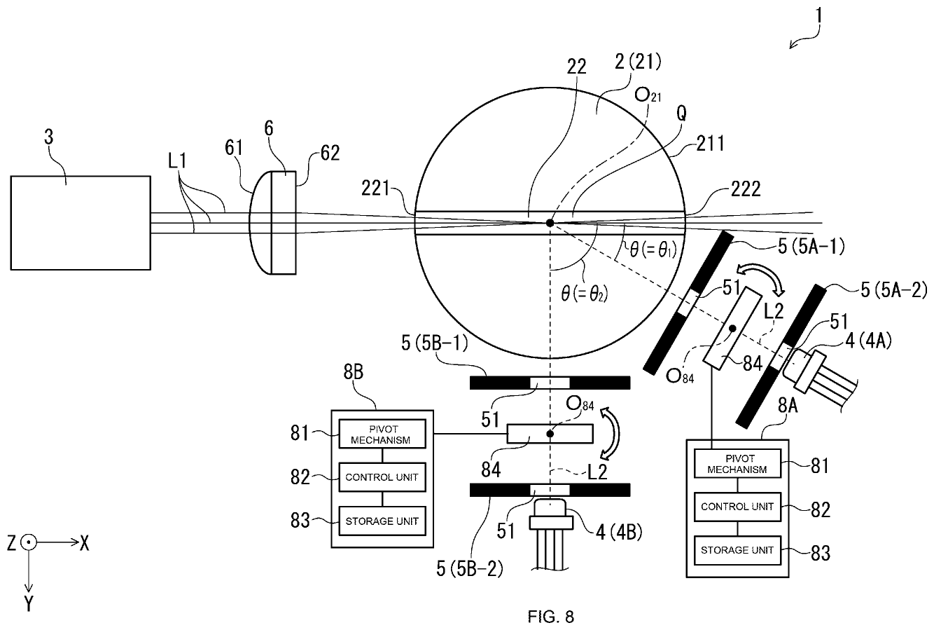

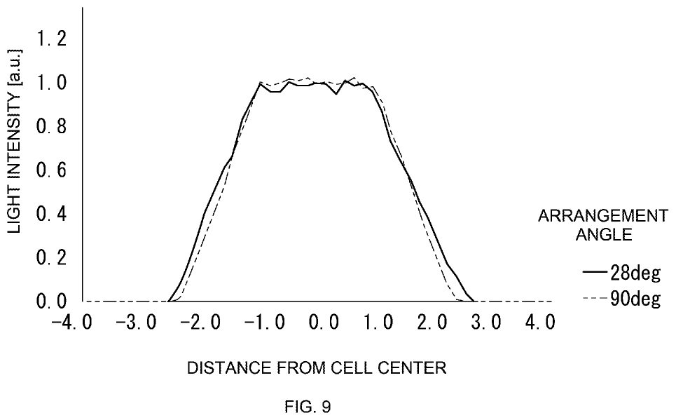

FIG. 8 is a plan view illustrating a light scattering detection device in the fourth embodiment of the present invention. FIG. 9 is a graph illustrating a relative value of the intensity of scattering light received by each detector at each arrangement angle in the case of using the light scattering detection device illustrated in FIG. 8.

While the light scattering detection device and the light scattering detection method in the fourth embodiment of the present invention are described below with reference to these drawings, the description is mainly given to the difference from the embodiments described earlier to omit the description on similar points.

The present embodiment is same as the second embodiment except for including a pivot unit instead of the moving unit.

As illustrated in FIG. 8, a light scattering detection device 1 in the present embodiment includes a pivot unit 8A and a pivot unit 8B. The pivot unit 8A and the pivot unit 8B have the same configuration except for being arranged in different areas and thus the pivot unit 8A is described below as a representative example. In the light scattering detection device 1, the pivot unit 8B may be omitted depending on the magnitude of the arrangement angle θ₂.

The pivot unit 8A has a ray adjusting member 84 arranged between the first aperture plate 5A-1 and the second aperture plate 5A-2, a pivot mechanism 81 configured to pivot the ray adjusting member 84, a control unit 82 configured to control activation of the pivot mechanism 81, and a storage unit 83 configured to store the refractive index information of the solvent in the liquid sample Q.

The pivot mechanism 81 is coupled to the ray adjusting member 84 and is configured with, for example, a motor, a reduction gear, and the like. The pivot mechanism 81 is capable of pivoting the ray adjusting member 84 about a pivot axis O₈₄ in parallel with the Z axis direction, that is, in the horizontal directions.

The ray adjusting member 84 pivots about the pivot axis O₈₄ to allow adjustment of the position of the scattering light L2 (light ray) from the first aperture plate 5A-1 towards the second aperture plate 5A-2. The ray adjusting member 84 is configured with parallel plate glass. This allows the ray adjusting member 84 to have simple configuration and it is thus possible to, for example, lower production costs of the ray adjusting member 84.

In the storage unit 83, refractive index information of solvents in various liquid samples Q is stored.

The control unit 82 extracts the refractive index information of the solvent in the liquid sample Q as a target for analysis from the storage unit 83. The control unit 82 then activates the pivot mechanism 81 based on the extracted refractive index information of the solvent to control the amount of pivot (pivot angle) of the ray adjusting member 84.

In the scattering light partly preventing step, it is possible to horizontally pivot the ray adjusting member 84 based on the refractive index information of the solvent in the liquid sample Q.

With the light scattering detection device 1 configured as just described, a result of the graph as illustrated in FIG. 9 is obtained. As clearly understood from the graph in FIG. 9, the graph of light intensity corresponding to each arrangement angle θ substantially overlaps with each other regardless of the magnitude of the arrangement angle θ and the deviation is thus prevented. This allows accurate calculation of, for example, the molecular weight and the particle size regardless of the positions where the detectors 4 are arranged.

Although the light scattering detection device and the light scattering detection method of the present invention has been described with reference to the illustrated embodiments, the present invention is not limited to them. In addition, each component constituting the light scattering detection device may be substituted by an arbitrary configuration capable of exhibiting the same function. Still in addition, an arbitrary configuration may be added. The light scattering detection device and the light scattering detection method of the present invention may be a combination of two or more arbitrary configurations (features) in the respective embodiments above.

### Aspects

Those skilled in the art understand that the plurality of embodiments described above as exemplifications are specific examples of the following aspects.

First Aspect: A light scattering detection device according to an aspect is a light scattering detection device for detecting fine particles in a liquid sample, including:

a transparent sample cell configured to retain the liquid sample;

a light source configured to irradiate the sample cell with coherent light;

a plurality of detectors configured to receive scattering light with different scattering angles around the sample cell; and

a plurality of apertures arranged between the sample cell and the respective detectors and configured to partly prevent the scattering light from being incident on the detectors, the geometric range of the prevention being defined by opening widths of the apertures, wherein

the sample cell has a sample channel formed linearly through the sample cell, the channel configured to enclose the liquid sample,

the light source is arranged to pass the coherent light incident on one end side of the sample channel through the sample channel,

the plurality of detectors are arranged on a circumference about a central axis of the sample cell, the central axis extending vertically, and

each aperture has an opening width to be maximum at an arrangement angle of 90° to an incident direction of the coherent light on the sample cell and to decrease with the arrangement angle away from 90°.

In accordance with the light scattering detection device according to the first aspect, it is possible to match, that is, equalize the size of the region where the reception area of each detector and the scattering light generation area overlap regardless of the arrangement angle. The light intensity in each detector thus becomes substantially same, that is, falls within tolerance. It is thus possible to maintain, for example, good calculation accuracy of molecular weight and particle size without depending on the arrangement angles of the detectors.

Second Aspect: In the light scattering detection device according to the first aspect, each of the apertures has the opening width of a value obtained by multiplying a distance from the central axis of the sample cell to the detector by a sine value of an arrangement angle of the detector.

In accordance with the light scattering detection device according to the second aspect, it is possible to more accurately match, that is, equalize the size of the region where the reception area of each detector and the scattering light generation area overlap regardless of the arrangement angle.

Third Aspect: In the light scattering detection device according to the first or second aspect, each aperture has a first aperture plate arranged on a side of the sample cell and a second aperture plate arranged on a side of the detector.

In accordance with the light scattering detection device according to the third aspect, it is possible to partly prevent the scattering light from being incident on the detectors without excess and deficiency.

Fourth Aspect: In the light scattering detection device according to the third aspect, the device further includes a moving mechanism configured to move the first aperture plate horizontally in parallel with the second aperture plate.

In accordance with the light scattering detection device according to the fourth aspect, it is possible to adjust the position of the first aperture plate.

Fifth Aspect: In the light scattering detection device according to the fourth aspect, the moving mechanism moves the first aperture plate based on refractive index information of a solvent in the liquid sample.

In accordance with the light scattering detection device according to the fifth aspect, it is possible to equalize the light intensity received in each detector by, when, for example, the refractive index of the solvent is different from the refractive index of the sample cell, adjusting the position of the first aperture plate.

Sixth Aspect: In the light scattering detection device according to the third aspect, the device further includes a moving mechanism configured to move the second aperture plate and the detector horizontally in parallel with the first aperture plate.

In accordance with the light scattering detection device according to the sixth aspect, it is possible to collectively adjust the positions of the second aperture plate and the detector.

Seventh Aspect: In the light scattering detection device according to the sixth aspect, the moving mechanism moves the second aperture plate and the detector based on refractive index information of a solvent in the liquid sample.

In accordance with the light scattering detection device according to the seventh aspect, it is possible to equalize the light intensity received in each detector by, when, for example, the refractive index of the solvent is different from the refractive index of the sample cell, adjusting the positions of the second aperture plate and the detector.

Eighth Aspect: In the light scattering detection device according to the third aspect, each aperture has:

a ray adjusting member arranged between the first aperture plate and the second aperture plate and configured to adjust a position of a light ray from the first aperture plate towards the second aperture plate; and

a pivot mechanism configured to horizontally pivot the ray adjusting member.

In accordance with the light scattering detection device according to the eighth aspect, it is possible to perform fine adjustment of the position of a light ray from the first aperture plate towards the second aperture plate.

Ninth Aspect: In the light scattering detection device according to the eighth aspect, the pivot mechanism pivots the ray adjusting member based on refractive index information of a solvent in the liquid sample.

In accordance with the light scattering detection device according to the ninth aspect, it is possible to equalize the light intensity received in each detector by, when, for example, the refractive index of the solvent is different from the refractive index of the sample cell, adjusting the position of a light ray from the first aperture plate towards the second aperture plate.

Tenth Aspect: In the light scattering detection device according to the ninth aspect, the ray adjusting member is configured with parallel plate glass.

In accordance with the light scattering detection device according to the tenth aspect, the ray adjusting member is allowed to have simple configuration and it is thus possible to, for example, lower production costs of the ray adjusting member.

Eleventh Aspect: A light scattering detection method according to an aspect is a light scattering detection method for detecting fine particles in a liquid sample, including the steps of:

enclosing the liquid sample in a sample channel formed linearly through a transparent sample cell configured to retain the liquid sample;

irradiating coherent light from a light source from one end side of the sample channel to pass the coherent light through the sample channel; and

receiving scattering light with different scattering angles around the sample cell by a plurality of detectors arranged on a circumference about a central axis of the sample cell extending vertically, wherein

the receiving scattering light includes partly preventing the scattering light from being incident on the respective detectors, the geometric range of the prevention being defined by opening widths of a plurality of apertures arranged between the sample cell and the respective detectors, and

each aperture has an opening width to be maximum at an arrangement angle of 90° to an incident direction of the coherent light on the sample cell and to decrease with the arrangement angle away from 90°.

In accordance with the light scattering detection method according to the eleventh aspect, it is possible to match, that is, equalize the size of the region where the reception area of each detector and the scattering light generation area overlap regardless of the arrangement angle. The light intensity in each detector thus becomes substantially same, that is, falls within tolerance. It is thus possible to maintain, for example, good calculation accuracy of molecular weight and particle size without depending on the arrangement angles of the detectors.

Twelfth Aspect: In the light scattering detection method according to the eleventh aspect, each of the apertures has the opening width of a value obtained by multiplying a distance from the central axis of the sample cell to the detector by a sine value of an arrangement angle of the detector.

In accordance with the light scattering detection method according to the twelfth aspect, it is possible to more accurately match, that is, equalize the size of the region where the reception area of each detector and the scattering light generation area overlap regardless of the arrangement angle.

Thirteenth Aspect: In the light scattering detection method according to the eleventh or twelfth aspect, each aperture has a first aperture plate arranged on a side of the sample cell and a second aperture plate arranged on a side of the detector.

In accordance with the light scattering detection method according to the thirteenth aspect, it is possible to partly prevent the scattering light from being incident on the detectors without excess and deficiency.

Fourteenth Aspect: In the light scattering detection method according to the thirteenth aspect, the partly preventing scattering light moves the first aperture plate horizontally in parallel with the second aperture plate based on refractive index information of a solvent in the liquid sample.

In accordance with the light scattering detection method according to the fourteenth aspect, it is possible to equalize the light intensity received in each detector by, when, for example, the refractive index of the solvent is different from the refractive index of the sample cell, adjusting the position of the first aperture plate.

Fifteenth Aspect: In the light scattering detection method according to the thirteenth aspect, the partly preventing scattering light moves the second aperture plate and the detector horizontally in parallel with the first aperture plate based on refractive index information of a solvent in the liquid sample.

In accordance with the light scattering detection method according to the fifteenth aspect, it is possible to collectively adjust the positions of the second aperture plate and the detector.

Sixteenth Aspect: In the light scattering detection method according to the thirteenth aspect, each aperture has a ray adjusting member arranged between the first aperture plate and the second aperture plate and configured to adjust a position of a light ray from the first aperture plate towards the second aperture plate, and

the partly preventing scattering light horizontally pivots the ray adjusting member based on refractive index information of a solvent in the liquid sample.

In accordance with the light scattering detection method according to the sixteenth aspect, it is possible to equalize the light intensity received in each detector by, when, for example, the refractive index of the solvent is different from the refractive index of the sample cell, adjusting the position of a light ray from the first aperture plate towards the second aperture plate.

Seventeenth Aspect: In the light scattering detection method according to the sixteenth aspect, the ray adjusting member is configured with parallel plate glass.

In accordance with the light scattering detection method according to the seventeenth aspect, the ray adjusting member is allowed to have simple configuration and it is thus possible to, for example, lower production costs of the ray adjusting member.

What is claimed is:

1. A light scattering detection device for detecting fine particles in a liquid sample, comprising:
a transparent sample cell configured to retain the liquid sample;
a light source configured to irradiate the sample cell with coherent light;
a plurality of detectors configured to receive scattering light with different scattering angles around the sample cell; and
a plurality of apertures arranged between the sample cell and the respective detectors and configured to partly prevent the scattering light from being incident on the detectors, the geometric range of the prevention being defined by opening widths of the apertures, wherein
the sample cell has a sample channel formed linearly through the sample cell, the channel configured to enclose the liquid sample,
the light source is arranged to pass the coherent light incident on one end side of the sample channel through the sample channel,
the plurality of detectors are arranged on a circumference about a central axis of the sample cell, the central axis extending vertically,
the detectors includes, where a position at an angle of 90° to an incident direction of the coherent light on the sample cell is defined as a reference position, first and second detectors arranged in proximal and distal positions with respect to the reference position, respectively, and
a first aperture for the first detector has a greater opening width than a second aperture for the second detector.

2. The light scattering detection device according to claim 1, wherein each of the apertures has the opening width of a value obtained by multiplying a distance from the central axis of the sample cell to the detector by a sine value of an arrangement angle of the detector.

3. The light scattering detection device according to claim 1, wherein each aperture has a first aperture plate arranged on a side of the sample cell and a second aperture plate arranged on a side of the detector.

4. The light scattering detection device according to claim 3, further comprising a moving mechanism configured to move the first aperture plate horizontally in parallel with the second aperture plate.

5. The light scattering detection device according to claim 4, wherein the moving mechanism moves the first aperture plate based on refractive index information of a solvent in the liquid sample.

6. The light scattering detection device according to claim 3, further comprising a moving mechanism configured to move the second aperture plate and the detector horizontally in parallel with the first aperture plate.

7. The light scattering detection device according to claim 6, wherein the moving mechanism moves the second aperture plate and the detector based on refractive index information of a solvent in the liquid sample.

8. The light scattering detection device according to claim 3, wherein
each aperture has:
a ray adjusting member arranged between the first aperture plate and the second aperture plate and configured to adjust a position of a light ray from the first aperture plate towards the second aperture plate; and
a pivot mechanism configured to horizontally pivot the ray adjusting member.

9. The light scattering detection device according to claim 8, wherein the pivot mechanism pivots the ray adjusting member based on refractive index information of a solvent in the liquid sample.

10. The light scattering detection device according to claim 8, wherein the ray adjusting member is configured with parallel plate glass.

11. A light scattering detection method for detecting fine particles in a liquid sample, comprising the steps of:
enclosing the liquid sample in a sample channel formed linearly through a transparent sample cell configured to retain the liquid sample;
irradiating coherent light from a light source from one end side of the sample channel to pass the coherent light through the sample channel; and
receiving scattering light with different scattering angles around the sample cell by a plurality of detectors arranged on a circumference about a central axis of the sample cell extending vertically, wherein
the receiving scattering light includes partly preventing the scattering light from being incident on the respective detectors, the geometric range of the prevention being defined by opening widths of a plurality of apertures arranged between the sample cell and the respective detectors,
the plurality of detectors includes, where a position at an angle of 90° to an incident direction of the coherent light on the sample cell is defined as a reference position, first and second detectors arranged in proximal and distal positions with respect to the reference position, respectively, and
a first aperture for the first detector has a greater opening width than a second aperture for the second detector.

12. The light scattering detection method according to claim 11, wherein each of the apertures has the opening width of a value obtained by multiplying a distance from the central axis of the sample cell to the detector by a sine value of an arrangement angle of the detector.

13. The light scattering detection method according to claim 11, wherein each aperture has a first aperture plate arranged on a side of the sample cell and a second aperture plate arranged on a side of the detector.

14. The light scattering detection method according to claim 13, wherein the partly preventing scattering light moves the first aperture plate horizontally in parallel with the second aperture plate based on refractive index information of a solvent in the liquid sample.

15. The light scattering detection method according to claim 13, wherein the partly preventing scattering light moves the second aperture plate and the detector horizontally in parallel with the first aperture plate based on refractive index information of a solvent in the liquid sample.

16. The light scattering detection method according to claim 13, wherein
each aperture has a ray adjusting member arranged between the first aperture plate and the second aperture plate and configured to adjust a position of a light ray from the first aperture plate towards the second aperture plate, and
the partly preventing scattering light horizontally pivots the ray adjusting member based on refractive index information of a solvent in the liquid sample.

17. The light scattering detection method according to claim 16, wherein the ray adjusting member is configured with parallel plate glass.
